(19) United States
(12) Patent Application Publication
(10) Pub. No.: US 2005/0037211 A1
(43) Pub. Date: Feb. 17, 2005

(54) Retroreflective materials

(76) Inventors: Michael John Sleeman, Holmes Chapel (GB); Colin Edward Woods, Kensington (GB)

Correspondence Address: James E Bradley;Bracewell & Patterson, PO Box 61389, Houston, TX, 77208-1389, US

(21) Appl. No.: 10/501,792

(22) PCT Filed: Jan. 10, 2003
(86) PCT No.: PCT/GB03/00069

(30) Foreign Application Priority Data
Jan. 16, 2002 (GB) 0200905.8

(51) Int. Cl. B32B 9/06

(52) U.S. Cl. 428/452; 427/331; 428/324; 428/328

(57) ABSTRACT

A retroreflective material in which the coating used to produce or enhance retroreflectivity and which bridges at least some of the gaps between the beads is treated and/or removed to produce areas of contrast which may represent patterning and/or graphical and/or pictorial matter without significantly affecting the retroreflective properties of the beads, if at all, and/or which may result in a different colour to conventional silvery grey coloured retroreflective materials.

This invention relates to retroreflective materials such as tapes and a method for producing such materials with patterned areas and/or graphical and/or pictorial information.

Retroreflective materials such as tapes are used to impart night conspicuity to garments, and are required to be made to exacting standards.

Conventionally, such retroreflective materials are made by hemispherically coating, e.g. metallising, a layer of microbeads while held on a web partly submerged in a coating on the web and transferring the layer of coated beads, uncoated side facing outwards, on to a substrate so that the non-coated or unmetallised areas of the beads are then exposed. The coating or metallisation process results in the coating or metal covering not only the beads but also extending across the gaps between the beads. A retroreflective material made in this way is herein referred to a retroreflective material of the kind referred to. Instead of coating by metallising, the coating may be a suitable material causing retroreflection in the beads and may be in the form of a metal (e.g. aluminium) flake or mica containing medium such as a paint or lacquer. However, the coating used to produce or enhance retroreflectivity need not be metal-based.

These materials are usually made to comply with the European EN471 standard. If it is required to apply printed matter, the problem of reduced retroreflectivity arises since the printing medium will tend to reduce retroreflectivity.

The present invention seeks to provide retroreflective materials, especially EN471 tapes, with graphical and/or pictorial matter and/or patterned areas without deleteriously affecting retroreflectivity.

According to the present invention there is provided a retroreflective material of the kind referred to in which the coating (e.g. a metal) used to produce or enhance retroreflectivity and which bridges at least some of the gaps between the beads is treated and/or removed to produce areas of contrast.

In this way, by selective removal or treatment of the coating, the areas of contrast may be arranged to represent patterning and/or graphical and/or pictorial matter without signicantly affecting the retroreflective properties of the beads, if at all.

Alternatively, the coating bridging substantially all of the gaps between the beads may be removed or treated to produce a material (e.g. tape) which is of a different colour to conventional silvery grey coloured tape.

The retroreflective material may be EN471 compliant.

The material may be a tape for sewing or otherwise attaching to a garment or other artefact. The material may, however, be sheet suitable for example as a garment panel.

The removal of the coating may expose the underlying substrate and, if desired, the substrate may be coloured (using a dye or pigment) or otherwise adapted to produce a desired effect.

Where the contrast is produced by treatment of the coating, such treatment may involve chemical treatment (e.g. attack) of the coating with or without a colourant to produce a coloured region.

According to another aspect of the invention there is provided a method of modifying the appearance of a retroreflective material of the kind referred to (e.g. by applying patterning and/or graphical and/or pictorial matter to the material) in which the coating (e.g. metal) used to produce or enhance retroreflectivity and which bridges at least some of the gaps between the beads is treated and/or removed to produce areas of contrast.

The areas of contrast may correspond to the desired patterning and/or graphical and/or pictorial matter.

Removal or treatment of the coating may be effected using a medium capable of being applied by a contact or non-contact printing technique and capable of dissolving or otherwise rendering the metal removable, e.g. by washing, or by changing the visual appearance, e.g. colour, of the coating.

The medium is typically selected to be one which does not attack the substrate in which the beads are embedded thereby preventing or reducing any tendency for the medium to attack the coating adhered to the embedded bead surfaces.

Instead of, or in addition to, removing the coating, it may be treated to render the treated areas visibly distinct from the coating adhered directly to the beads. Such treatment may result in the treated areas being visibly distinguishable from those areas from which coating has been removed.

The medium may be in the form of a liquid, paste-like or gel-like medium which can be applied by a printing technique in relatively well-defined areas without spreading. To this end, the medium may incorporate a thickening or viscosity enhancing agent to reduce its tendency to spread once printed on to the retroreflective material. Once the medium has had the desired effect, it may be washed off.

The medium may also include surface tension controlling or modifying agents to improve the quality of printing.

The medium may be alkaline.

The invention will now be described by way of example only with reference to the accompanying drawings, in which:

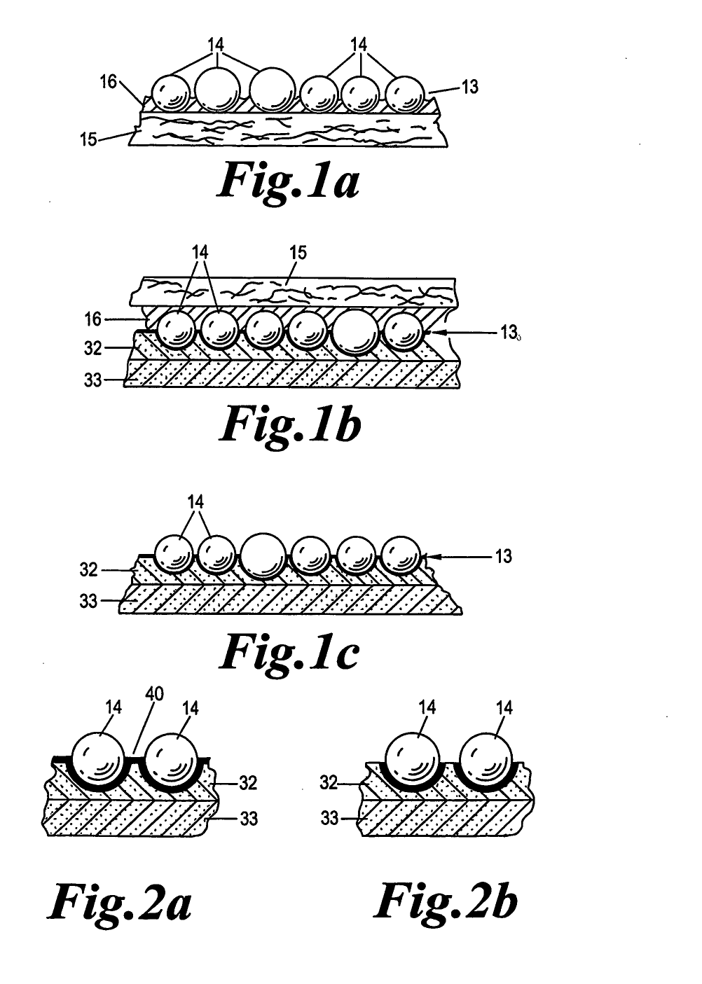

FIGS. 1a to 1c are diagrammatic views representing different stages during the production of a retroreflective tape of the kind referred to;

FIG. 2a is an enlarged view corresponding to FIG. 1c illustrating the presence of metal bridging the gaps between adjacent beads; and

FIG. 2b is the counterpart of FIG. 2a following removal of metal from the gaps.

Referring to FIGS. 1a to 1c, a retroreflective material in the form of a tape may be manufactured in the manner disclosed in International Patent Application No. WO 00/54079, the entire contents of which are incorporated herein by this reference. The production process involves forming a layer 13 of spherical glass beads 14 embedded into a melt adhesive 16 such as a linear low density polyethylene (LLDPE) carried by a web 15 which may be Kraft paper or a polyester film for example. The exposed surfaces of the beads 14 are then metallised, e.g. using aluminium, with the consequence that the coating 16 is also covered with aluminium at the gaps between adjacent beads 14. Typically, the microbeads used may be between 53 and 75 microns in diameter (200-270 US mesh size) and may have a refractive index close to 1.9 (e.g. 1.92 or 1.93). Flex-o-Lite® TSTF (twice sieved, twice fired) have been found to be suitable beads.

A second adhesive film 32 such as a polyurethane film (e.g. a polyester-based polyurethane which optionally may contain a blocked isocyanate) carried by a sheet 33 (which may itself be a melt adhesive layer such as a thermoplastic co-polyamide, co-polyester or polyurethane) is then laminated to the metalised layer 13 of beads (see FIG. 1b) and is used to strip the layer of beads from the coating 16 to produce the product shown in FIG. 1c. This product comprises a substrate comprising melt adhesive layer 32 in which the beads 14 are embedded with their unmetallised surfaces exposed. At this stage, it will be noted that the metal bridging the gaps between the beads has now been transferred to the substrate formed by melt adhesive layer 32. Depending on the size distribution of the beads and the bead scattering process, the areas between the beads may typically be of the order of 10% of the total cross-sectional area of the beads.

Printing of the resulting retroreflective material is effected in accordance with the present invention by treating and/or removing the aluminium or other metal used in the metallisation step from the gaps 40 between microbeads (see FIGS. 2a and 2b illustrating the material before and after removal of the metal) over regions corresponding to the matter to be printed when graphical or pictorial or in the form of a pattern or design.

In one example of the invention this was achieved by printing the design or graphical information on to that face of the material (in this case an EN471 compliant retroreflective tape commercially available from Reflec plc of Winsford, UK) at which the microbeads are exposed using a stylus dipped into a 0.8M aqueous solution of potassium hydroxide. After allowing sufficient time for the hydroxide to react with the metal (typically about 30 seconds), the tape was rinsed in water and left to dry. The resulting design (as represented by areas of the tape from which the metal has been removed) was clearly visible both before and after the tape had been applied to a garment using a heated press. This indicates that the metal in the areas between the beads had been selectively removed to expose the plastics/polymeric layer in which the beads are embedded.

Although in the foregoing example an alkali, namely potassium hydroxide, is used to dissolve away the silvery grey aluminium in the areas between the beads, it will be appreciated that other agents (alkaline, acidic or otherwise) may be used to effect the removal of the aluminium or other retroreflectivity-enhancing material, the agent selected being one which does not attack, at least not to any signficant extent, the plastics/polymeric layer in which the beads are embedded so that the layer of material then serves to protect the hemispherical coating of metal on each bead from attack thereby preserving the retroreflective properties of the material. The plastics/polymeric substrate in which the beads are embedded may incorporate a dye or pigment determining the colour seen following removal of the metal at the inter-bead gaps.

A suitable coloured, or dye or pigment-containing, alkali or other agent can also be used to effect a change in the visual appearance/colour of the bridging material.

The method of the invention may be used to give the effect of printing or it may be used to remove/treat the metal at substantially all of the inter-bead gaps to modify the coloured appearance of the retroreflective material.

1-18. (cancelled)

19. A retroreflective material of the kind referred to in comprising a coating and a plurality of beads, the coating being applied to at least portion of the plurality of beads to produce or enhance retroreflectivity of the plurality of the beads and which bridges at least some of gaps between the plurality of beads, the coating being treated and/or removed to produce areas of contrast.

20. The material as claimed in claim 19 in which the coating is removed selectively so that the areas of contrast represent patterning and/or graphical and/or pictorial matter.

21. The material as claimed in claim 19 in which the coating bridging substantially all of the gaps between the beads is removed or treated.

22. The material as claimed in claim 19 in a form of a tape.

23. The material as claimed in claim 19 in a form of a sheet.

24. The material as claimed in claim 19 in which the coating has been removed in such a way as to expose an underlying substrate.

25. The material as claimed in claim 24 in which the underlying substrate is colored.

26. The material as claimed in claim 19 in which the areas of contrast are produced by chemical treatment of the coating.

27. The material as claimed in claim 26 in which the chemical treatment involves coloring of the coating.

28. The material as claimed in claim 19 in which the coating is metal based.

29. The material as claimed in claim 19 in which the coating has been affected by metallization.

30. The material as claimed in claim 19 in which the coating comprises a medium containing elements imparting retroreflectivity.

31. The material as claimed in claim 30 in which the elements comprise metal flake or mica.

32. A method of modifying an appearance of a retroreflective material of the kind referred to comprising the steps of:
supplying a plurality of beads;
applying a coating to at least a portion of the plurality of beads to produce or enhance retroreflectivity of the plurality of the beads and to bridge at least some of gaps between the plurality of beads; and
treating and/or removing at least a portion of the coating to produce areas of contrast.

33. The method as claimed in claim 32 in which the areas of contrast correspond to desired patterning and/or graphical and/or pictorial matter.

34. The method as claimed in claim 32 wherein the step of treating and/or removing at least a portion of the coating to produce areas of contrast includes using a medium capable of being applied by a contact or non-contact printing technique and capable of dissolving or otherwise rendering metal removable or changing a visual appearance.

35. The method as claimed in claim 32 wherein the step of treating and/or removing at least a portion of the coating to produce areas of contrast includes rendering treated portions of the coating visibly distinct from the coating adhered directly to the beads.

36. The method as claimed in claim 35, wherein the step of treating and/or removing at least a portion of the coating to produce areas of contract includes removing the coating in parts and in which said treatment is such as to result in the treated portions of the coating being visibly distinguishable from those areas from which the coating has been removed.
